(19) United States
(12) Patent Application Publication
(10) Pub. No.: US 2014/0284068 A1
(43) Pub. Date: Sep. 25, 2014

(54) FIRE DOOR LEAF FOR CERTIFIED USE

(71) Applicant: BOCON HOLDING AS, Bodø (NO)

(72) Inventor: Espen Dobakk, Bodo (NO)

(21) Appl. No.: 14/359,887

(22) PCT Filed: Nov. 22, 2012
(86) PCT No.: PCT/NO2012/050234

§ 371 Date: May 21, 2014

(30) Foreign Application Priority Data
Nov. 22, 2011 (NO) 20111608

(51) Int. Cl. A62C 2/06

(52) U.S. Cl. CPC A62C 2/06
USPC 169/48

(57) ABSTRACT

Fire door leaf for industrial use in relation to openings in structures such as buildings, vessels and/or land and sea-based oil and gas installations, where the fire door with said fire door leaf contributes to providing a passage between different compartments in said structures. The fire door leaf is constructed to work as an element in a certified barrier against the spreading of fire, smoke and/or pressure. The leaf comprises two leaf elements where each leaf element comprises a main surface, and where the leaf elements assembled is suitable to forming a volume between themselves without stiffening elements within the volume. At least one main surface comprises a single-curved surface.

This invention relates to general security in structures such as buildings, vessels and land and sea-based oil and gas installations. More specifically this invention concerns safety in the event of fire, explosion and flooding where the main purpose is to improve safety. Specifically this invention is a barrier to be closed when necessary as a fireproof door for heavy duty industrial use. Said fire door comprises a door leaf with one or more curved surfaces.

### FIELD OF THE INVENTION

Safety in structures such as buildings, vessels and land and sea-based oil and gas installations relates to a number of different aspects including fire, explosions and flooding. Said barrier will usually have to be certified. Such certification is regulated by amongst others a number of standards.

Generally when defining the fire class we relay on the risk classification, because the utilisation of the building along with its size and floor plan determines the consequences of a fire and therefore the requirements to the barrier. A building can be given a fire class between 1 and 4. Fire class 1 is given to buildings or vessels where a fire will have small consequences, and fire class 4 is given to buildings where a fire would have extensive consequences for the local community or the environment. The resistance to fire is generally determined by four criteria; load-bearing capacity (R), integrity (E), insulation (I), mechanical resistance (M). When stating these criteria the minimum time of resistance in minutes is added as a postfix, and only listing the relevant criteria for the section of the building. A fireproof wall doesn't necessarily have to provide load capacity or mechanical resistance and can usually be given a fire resistance of EI 30, which means that it is capable of resisting fire for at least 30 minutes. When classifying fire doors three classes are used. Class A means a door made in inflammable material such as steel, class B means a door made in flammable material such as wood or class H. For instance, a door can have a fire classification of A60 (fire class A for 60 minutes) or H120 (fire class H (hydrocarbon fire) for 120 minutes).

A fire door is used as a part of a passive fire protection system which purpose is to be a barrier against fire, smoke and heat between parts/sections of a building, a structure or a vessel. The door also provides an exit from said section. A fire door is often defined as a door capable of preventing heat from penetrating for a certain time for a given fire class such as later described.

Fire doors are often supposed to be able to resist pressure as a result of explosions or water pressure and also function as a sealed bulkhead in structures such as buildings, vessels and land and sea-based oil and gas installations. This property is given in pressure or energy.

There are a number of different types of fire doors. There are hinged doors with one or two door leaves. There are also sliding doors. The different types of doors can be combined. A fire door is usually comprised of a door leaf and door frame. The door frame usually has elements that seals against fire and smoke and structures to keep the fire door in place. Furthermore the door usually also has insulation, hinges, door pump, openers, windows etc.

Users of fire doors define the requirement specification based on the relevant use of the door. There may be major differences between such specifications; which complicates both the construction and production.

In the Chinese utility model application CN1995225028 “Fire-proof Steel Door” a fire door made of cold-rolled steel is presented.

Today there are a number of producers of fire-proof doors. They typically produce doors based on traditional design as shown in FIG. 1. The conventional design is characterised by among others that their door leaves are flat. The door also includes stiffening elements in the door leaf to provide the necessary strength. Such stiffening elements are often made of steel. The stiffening elements are supposed to help reduce deformation of the door when it is subject to physical forces such as heat generation in case of fire and/or pressure from an explosion. Such deformations of the door could lead to malfunction of both preventing the fire (heat) and smoke from spreading, but also when it comes to access to or exit from attached compartments. Consequently the doors function as a barrier will fail.

The field of expertise for fire-proof doors according to the invention for use in heavy, industrial applications is characterized by that such certificated barriers are to be specified, produced and documented according to specific standards they are supposed to comply with. This field of expertise substantially distinguishes itself from uncertified doors and the person skilled in the art will be a different one as described later.

A fire door according to the state of the art, not only includes stiffening elements, but they make up the most vital load-bearing elements. When the expert is to construct such a door, he will, based on the relevant opening size and the standard to be fulfilled, determine the design parameters and dimension the stiffening elements primarily based on the pressure to be resisted. Such dimensioning of the stiffeners is often made using analytical methods and standard formulas in a spreadsheet. Only later comes the dimensioning of thickness of the door with door leaf elements and insulation materials etc.

Documentation of a fire door is performed using established methods. The properties of the door including its strength and deflection, are usually documented analytically based on the known construction with stiffening elements. The analytical methods demand that the plate is plane an that the thickness is small in relation to the dimension in the other two directions. Furthermore the deformations have to be small and that level transverse section remains level. Standards and procedures are heavily established based on said construction. Changes are not likely because among others this concerns safety and also economical reasons. Certification of a fire door by means of testing is costly.

Production of a fire door according to the state of the art often includes that the door leafs edge are bent and welded in the corners. Further, the stiffening elements are welded on. Especially the stiffening elements will generally have different dimensions, particularly the thickness, than the door leaf elements. This results in that the door leaf may twist both during production when welding and in case of heating during a fire. Twisting of the door leads to difficulties when trying to get a good fit for the door in the door frame. In relations to the productions this leads to the need for readjusting which costs both money and time and in the case of a fire, the door may not form the barrier that complies with the requirements for the standard.

Standards and textbooks within the area of expertise documents the state of the art within the relevant area as described above (i.e. NS-EN 1993 “Prosjektering av stålkonstruksjoner” and the textbook “Dimensjonering av stålkonstruksjoner”, 2. edition bu Per Kr. Larsen).

Fire door solutions have according to the state of the art however have a number of different drawbacks. Several of the problems with today's doors are caused by the use of stiffening elements in the door leaves. The stiffening elements are troubling when it comes to safety as will be described further on. It is especially important that the stiffening elements pose a threat to the main purpose of the fire door, that is to prevent a fire from spreading. Said stiffening elements cause different parts of the door to expand at different rates when the temperature raises, and by that means the door leaf gets deformed or twisted and the ability of the door to function as a barrier decreases. Furthermore the heat is directed towards the core of the door, which makes it easier for heat to penetrate the door. The stiffening elements will also divide the insulation. Stiffening elements also causes drawbacks when it comes to the access function of the door, as they increase the weight and make the door slower and harder to operate by the user. The stiffeners also complicate the construction and production of the door. They need to be dimensioned differently depending on the dimension of the door and the relevant fire and explosion certification. Furthermore they restrict the placement of other door elements such as windows, screw holes for placement of equipment etc. Installation of the stiffeners is also labour-intensive because they usually require extensive welding. The use of stiffeners often causes the door to have to be dimensioned larger, which in terms makes the door more labour-intensive and expensive and also harder to operate by user.

Further drawbacks with solutions using today's technology with a flat door leaf include i.a. reduced resistance to pressure due to that the deformation of the door leaf may be so large that the gaskets around the door leaf may not be able to provide a sufficient seal.

To summarize; today's solutions have many drawbacks such as reduced safety, reduced ergonomics and slower operation, higher complexity, less possibilities for additional features, labour-intensive and they are expensive in production.

### DESCRIPTION OF THE INVENTION

This invention relates to a fire door leaf for industrial use related to openings in structures such as buildings, vessels and/or land and sea-based oil and gas installations, where the fire door with said fire door leaf helps providing a passage between different sections in said structures. The fire door leaf is furthermore designed to work as an element in a certified barrier against the spread of fire, smoke and/or pressure.

The door leaf comprises at least two leaf elements, where each element comprises a main surface, and where the assembled leaf elements are suitable to form a volume between themselves. At least one main surface comprises a single curved surface to provide the door leaf with the necessary load-bearing capability without stiffening elements within the volume. The door will contribute to increased safety and typically be able to form a barrier between warm and cold side. An embodiment of the invention is a heavy duty fire door.

It is advantageous that the fire door leaf expands mainly uniformly and without twisting in case of heating and that said volume without stiffening elements increase the insulating ability of the door leaf.

In a preferred embodiment one surface has a convex curving seen from the outside of the fire door leaf towards said surface.

The other main surface in relation to the at least one main surface, can principally be flat or involve a single curving convex surface seen from the outside of the fire door leaf towards said surface, or involve at least one single curved concave surface seen from the outside of the fire door leaf towards said surface.

The surfaces the leaf elements form against the inner volume of the door leaf, can advantageously be curving monotonously so they form a smooth surface which allows for continuous physical elements to be arranged such as insulating material.

The inner volume can primarily be filled with a solid or injected insulating material.

In a preferred embodiment the two main surfaces of the door leaf are rectangular.

Fire door leaves can furthermore be fitted with devices to provide the possibility of visual inspection through the door leaf. Said devices can include window-like elements. It is preferable that the door leaf is constructed to allow the placement of the window anywhere on the main surfaces on the door leaf.

It is also advantageous that when pressure is exerted on a main surface which comprises a single curved surface, it is designed in such way that forces are transferred towards the door frame providing an improved seal of the door.

A general objective of the invention is to solve problems with the state of the art.

A superior objective of the invention is to function as a barrier against spread of fire, smoke and/or pressure in relation to openings between sections of structures such as buildings, vessels or land- and sea-based oil and gas installation. A further purpose is to function as a waterproof barrier/bulkhead in vessels or oil and gas installations.

A substantial objective of the invention is to maintain the doors ability to function during influence of heat. A concrete purpose in relation to this is to reduce deformation of the door leaf generally and deformation that leads to a reduced function as a barrier particularly.

Another goal is to provide fire doors for said openings where the closing devises in closed state reduce heat transmission between the compartments. The solution especially provides reduced heat transport by means of the closing device, where the closing device is a heavy duty fire door for industrial uses.

Another goal is to provide fire doors for said openings where the closing devices prevent the spreading of pressure differences and/or fluids between sections. The solution especially provides reduced spreading of said character by forming a better seal between closing devices and adjacent parts of the opening.

A further goal for the invention is to provide solutions that allow for faster and easier operation; which has benefits both safety wise and ergonomically for the operator.

A concrete goal is to reduce the complexity and weight of the fire doors. This will have significance for safety and ergonomics as described above, and for cost as later described.

A further concrete goal is to provide a solution that can be used where conventional design proves too heavy, for instance in cabin doors. In addition the thickness of the door can be reduced because of less heat transmission through the door leaf when there are no stiffening elements in said door leaf.

Another objective is to reduce cost when it comes to construction, production and operation of the fire door. It is also of significance that the extent of welding required is reduced.

A further objective is to increase the possibilities for additional functionality of the fire door by means of for instance the placement of a window-like element in the door. In relation to this it is a further goal to increase the safety and provide means for visual inspection of conditions on the other side of the door to assess the situation of the opposite side of the door in relation to deciding whether or not to open the door.

Another important goal is to make it simpler and easier to establish means of escape through the door in the case it can not be opened.

It is also a goal to provide solutions which will be perceived as aesthetically pleasing.

### SHORT DESCRIPTION OF THE FIGURES

FIG. 1a shows a fire door leaf according to the state of the art as described in the corresponding chapter, where the fire door leaf is assembled in a frame and seen at an angle towards the anterior main surface.

FIG. 1 b-c shows two horizontal cross-sections through the door leaf respectively at A-A and B-B in FIG. 1a

FIG. 2a shows a draft of a door leaf according to the present invention seen at an angle towards an anterior main surface, where the door leaf comprises a flat and a curving door leaf element.

FIG. 2b-c shows two horizontal cross-sections through the door leaf respectively at A-A and B-B in FIG. 2a

FIG. 3a shows an alternative embodiment of a fire door according to the present invention, where the door leaf comprises to convex leaf elements.

FIG. 3b-c shows two horizontal cross-sections through the door leaf respectively at A-A and B-B in FIG. 3a.

### DETAILED DESCRIPTION OF THE INVENTION

Before embodiments of the invention are described, it is given as a background a presentation of a typical solution according to the state of the art. In relation to this it is mentioned that the state of the art is further described earlier in this patent text.

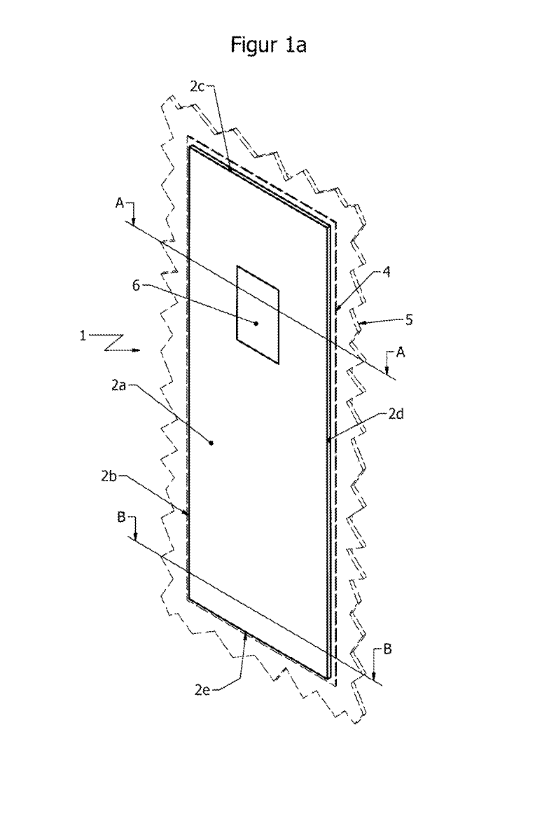

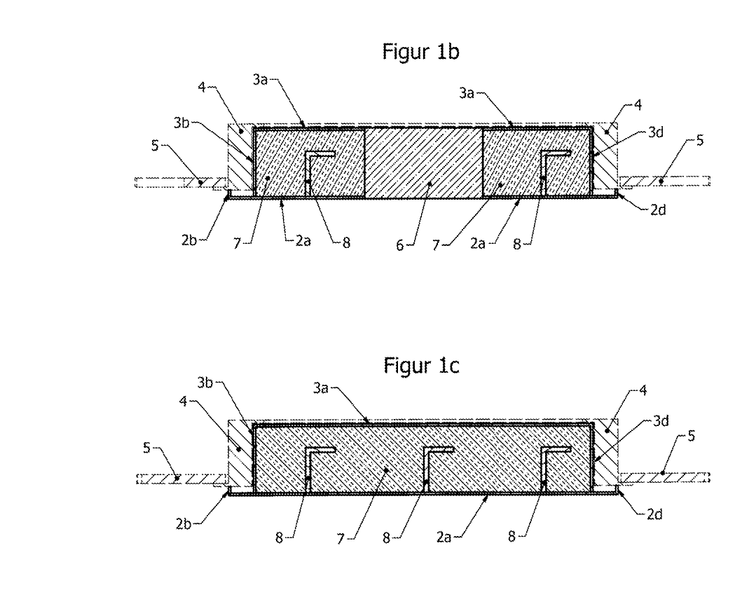

FIG. 1a shows a sketch of a door leaf (1) according to the state of the art seen at an angle towards an anterior main surface (2a), where the door leaf (1) involves two flat door leaf elements (2, 3) where only the anterior (2a) is shown in the figure. FIG. 1a also shows two axes A-A and B-B for use later in the description.

The FIGS. 1b and 1c show horizontal cross-sections at respectively A-A and B-B through a door leaf (1) according to the state of the art, where the door leaf is assembled on (a frame (4) by a wall (5). The door leaf's two door leaf elements (2, 3) form a space in which an insulation material (7) is arranged, and where there are stiffening elements (8) attached it to one of the door leaf elements (2). These stiffening elements (8) will typically be made of metal such as steel and be attached by welding. They protrude into the space between the door leaf elements (2, 3) and reduce the barrier distance, or possibly connect the door leaf's (1) two sides. Such a solution results in the forming of heat bridges through the door. In the event that the stiffening elements would not connect the two sides, which would result in worse primary function, but still cause problems from increased heat conductivity in the door leaf (1). The stiffening elements (8) will typically expand at a different rate and to a different level than the door leaf (1); which could possibly lead to unfortunate deformations such as twisting which in terms would negatively affect the door's properties as a barrier. FIG. 1b illustrates that a window-like element (6) has been installed into the door leaf and that it would not be possible to install stiffening elements at this position.

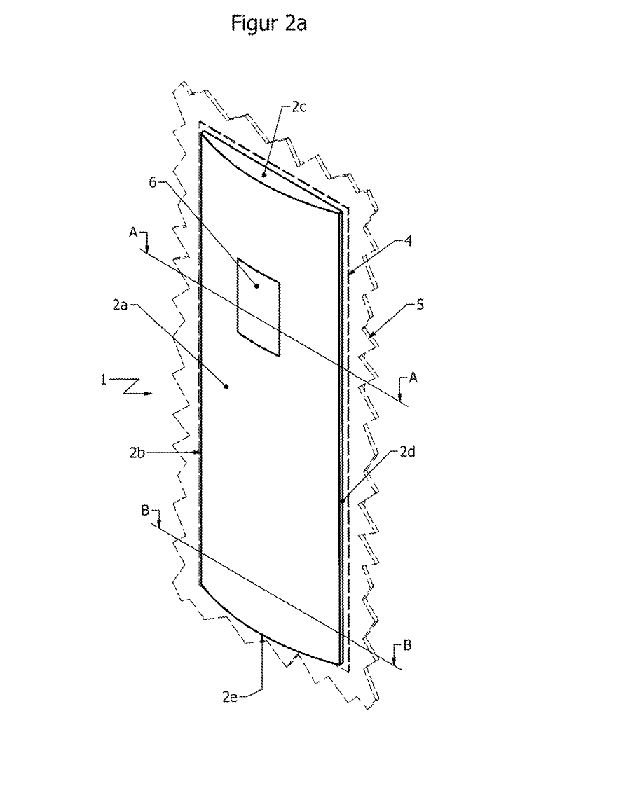

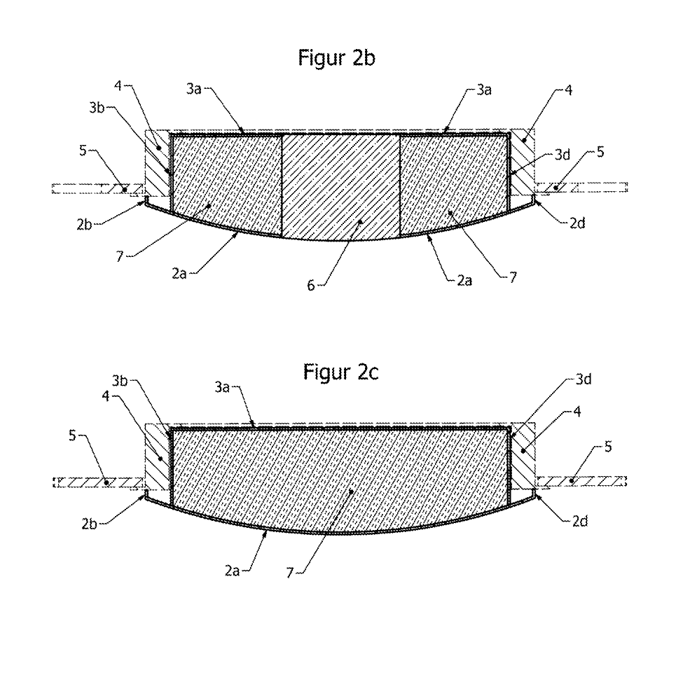

When it comes to this invention, it is presented in FIG. 2a-c a preferred embodiment of a door leaf (1) where a main side is mainly flat, while the opposite main side shows a curving. Among the scenarios that are relevant for such a door, is fire and heat generation where an increase in pressure typically happens on one side of the door. In relation to watertight bulkheads in boats and offshore constructions, one could have water pressure on both sides of the door.

More specifically FIG. 2a shows a sketch of the door leaf (1) seen at an angle towards the anterior main surface (2a), where it is also defined two axes A-A and B-B for later use. FIG. 2b shows a horizontal cross-section through the door leaf (1) at A-A in FIG. 2a and FIG. 2c show a cross-section through the door leaf (1) at B-B in FIG. 2a.

FIG. 2a illustrates a door leaf (1), where said door leaf (1) is installed in a frame (4) which further is installed in a wall (5). The figure illustrates how the window-like element (6) is going through the door leaf. The door leaf (1) typically involves two door leaf elements (2, 3), but can also be made with one element typically manufactured in a moulding process. Each of said door leaf elements (2c 3) involves one main surface (2a, 3a) and usually four end faces (2b-e or 3b-e, where 3c and 3e are not shown in the figure) per door leaf element (2, 3) where the two door leaf elements (2, 3) are shaped so they are suitable to form a door leaf (1) with a volume between said leaf elements (2, 3) as here shown filled with insulating material. In the door leaf (1) there is installed a window-like element (6) which allows for visual inspection through the door leaf (1).

The four end faces (2b-e, 3b-e) per leaf element (2, 3) typically involves two side end faces and one top and one bottom end face in reference to a door installed in a normal way. The side faces will typically have installed gasket elements (not shown on the figures) to contribute to sealing against the frame. The end faces (2b-e, 3b-e) contribute both in forming the door leaf with its inner space and to stiffen the door. The side end faces are designed to cooperate with the door frame (4) to improve the seal and reduce deformation of the door leaf (1) under strain.

In the present embodiment the exterior door leaf element (2) is designed so that it stands out over the end faces (3b-e) to the anterior door leaf element (3). Said out standing part with belonging side end face is constructed to cooperate with the belonging part of the door frame (4) to contribute to improving the door's ability to form a seal in closed state. The solution especially contributes to improving the doors ability to resist an increased pressure, for instance in the form of an explosion, on the external part of the door leaf (1). In this embodiment, this is achieved by that said out standing part meets the door frame (4). Furthermore, the door frame (4) is on the inner side of the door leaf (1) constructed with an out standing part shaped coordinating to the outer leaf element; which also contributes to improved sealing and strength in case of increased pressure, for instance as in an explosion on the interior side of the door. Furthermore, gaskets or gasket systems (not shown in the figures) can be installed to achieve the properties mentioned above.

FIG. 2a shows a sketch of a fire door according to the present invention where two axes A-A and B-B are defined for use later. FIGS. 2b and 2c shows horizontal cross-sections at respectively A-A and B-B through a door leaf (1) according to the state of the art, where the door leaf is installed in a frame (4) into a wall (5).

The main surfaces (2a, 3a) are characterized by that at least one of them is curved. In the illustrated embodiment in FIG. 2 the main surface (2a) is curved, but main surface (3a) is flat. The curving is convex for the surfaces (2a) seen towards the surface from the outside of the door leaf (1). The curving of the main surfaces is furthermore typically characterized by being single-curved by curving in the first direction, but being linear in the other direction along the main surface crosswise to the first direction.

The curved shape of the main surface (2a, 3a) will contribute to that the door leaf in assembled state will exhibits an increased rigidity and increased strength to resist external mechanical strain. A door leaf (1) will with a convex outer shape be suitable to resist strain from for example increased pressure.

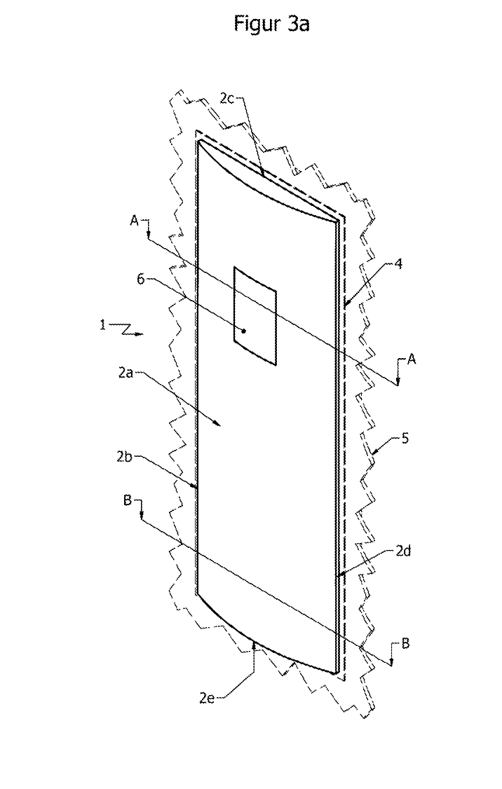

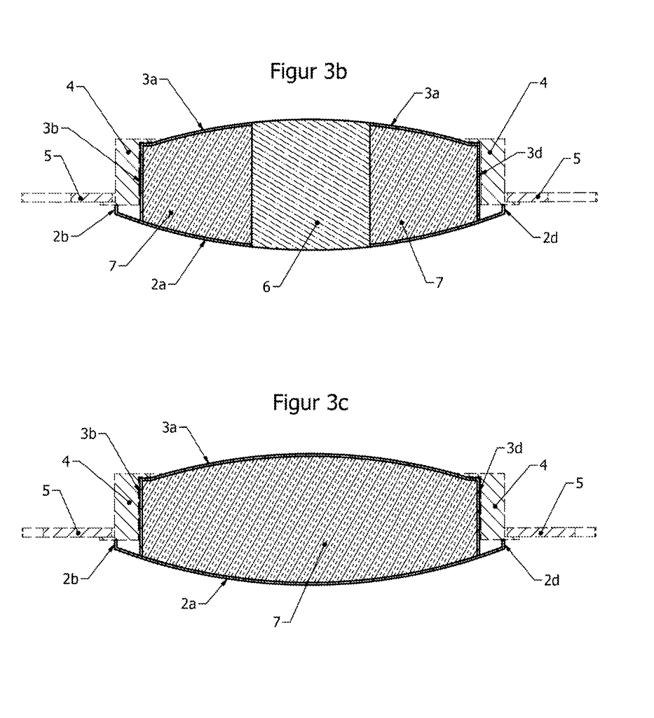

FIG. 3a-c shows an embodiment of a fire door according to the invention mainly as described in FIG. 2 and we are mainly referring to the relevant description. In the meantime the embodiment in FIG. 3 distinguishes itself from that of FIG. 2 by that both the door leaf elements are curved. The curving is convex for both the surfaces (2a, 3a) seen towards the surfaces from the outside of the door leaf (1). The curving of the main surfaces is furthermore typically characterized by being single-curved and by curving first in one direction, but being linear in another direction along the main surface crosswise to the first direction.

The curving shape of the main surfaces (2a, 3a) will contribute to that the door leaf in assembled state will exhibit an increased rigidity and increased strength to resist external mechanical strain. A door leaf (1) with a convex outer shape on both sides will be suitable to resist strain from for example increased pressure on any of the two sides.

In a further relevant embodiment, one of the leaf elements (2) still exhibits a convex shape, but the other leaf element (3) is concave. The curvatures of the two leaf elements (2, 3) can vary. In an embodiment the curvatures can be of the approximately the same magnitude in absolute value. Furthermore the two leaf elements (2, 3) are installed with their convex surfaces facing the same direction. This embodiment is best suited when the threat scenario is asymmetrical, which is considered the most common, by that a mechanical load such as increased pressure most likely happens on one side of the door. By that the convex sides of the two leaf elements (2, 3) both are faced towards the threat, the door leaf (1) will exhibit increased resistance. This requires a mechanical connection suitable to transfer forces between the main surfaces. Such a mechanical connection can be made of for instance insulating material.

The door leaf (1) can further involve a window-like element (6) that allows visual inspection through the door leaf (1) without having to open the door. This is advantageous i.a. because it can prevent the opening of the door when the situation on the other side is so that the door should not be opened for safety reasons, for instance in case of a fire. The window-like element (6) involves a transparent element in each of the two door leaf elements (2, 3) where the transparent elements are installed on each side of a transparent volume of the door leaf (1). In door leaves according to the state of the art, stiffeners would have to be cut or moved to provide the space for window element (6), but a solution according to this invention without stiffeners (8) allows for a less restricted placement of a window (6). The window (6) will typically be made of fire-proof glass with the same or better insulating ability than the door leaf (1) itself. The glass will typically be in two parts installed in the main surfaces (2a, 3a) in their own door element (2, 3) where the two pieces are not touching to reduce heat transfer. This door leaf solution contributes to make said window-like element (6) possible by that the door leaf (1) gets its stability from its shape, and stiffening elements (8) are not required within the door leaf (1).

The door leaf elements (2, 3) form in assembled state a volume between themselves which can be a mainly closed space (or a barrier). Said closed space can mainly be a homogeneous volume. The closed space is typically primarily filled with an insulating material (7). The insulation material (7) is usually chosen based on which fire class one tries to achieve. It is used passive types such as Rockwool and active types that vaporizes to absorb energy so that required fire class is achieved. It is often used a combination of said types of insulating materials.

The distribution of the insulation material (7) in the space is mainly allowed to be uniform since there are no stiffening elements (8) within the door leaf (1), which is advantageous because the insulation properties of the door leaf (1) is enhanced. In addition to providing an insulation effect, the insulating material can contribute to increasing the rigidity and stability of the door leaf (1). Every one of the inner surfaces of said space is primarily “smooth” in which it has a uniform curving and that there are no stiffening elements (8) within the door leaf (1). This makes possible an easy insertion of continuous insulating material. Such a continuous insulating material will have beneficial properties when it comes to reducing heat transfer through the door leaf (1). Furthermore will the filling of said space with material contribute to increasing the door leaf's stiffness and ability to withstand mechanical strain in the case of for example an explosion.

No stiffening elements (8) are attached to said main surfaces (2, 3). Such stiffening elements (8) will typically contribute to that a door leaf (1) will not expand evenly under thermal stress when the door is made of a material that expands with temperature, but rather twists with unfavourable effects on the door's function as a barrier. Twisting of the door leaf will typically result in openings against the door frame (4). Furthermore, a pressure against the curved surface can result in forces primarily along the leaf element with the curved surface crosswise the axis of the curving. The curved surface will therefore give advantages to the seal against the frame both during heat generation and pressure strain. When this door leaf is constructed to expand primarily evenly, without twisting when heated, it involves that the construction reduces drawbacks with a solution with stiffening elements as described above and in relation to the state of the art.

A force perpendicular (common for water pressure) to a leaf element will be decomposed with force components along the door leaf element. The force will contribute to expanding the door leaf's width and therefore in closed state contribute to force the door against a possible door frame. A curved surface will be able to contribute in transferring forces to the frame. The same goes for different embodiments of the door. The solution provides increased rigidity and resistance against certain mechanical strains such as for example pressure increases in the case of an explosion. The door leaf (1) in assembled state in the case of an increase in pressure on one side, will result in a better seal against the door frame both on the sides of the door as well as above and beneath this.

The door leaf is constructed to function as an element in a certified barrier against the spreading of fire, smoke and/or pressure. The door leaf elements are constructed primarily of metal. This involves that the elements comprise metal that typically makes up the greater part of the elements although the elements also can comprise other materials in relation to for example window elements.

The invention also relates to the simplification of establishing means of escape through a fire door. When there are no stiffeners within the door, one can with relatively simple tools such as a fireman's axe make an evacuation passage through the door; which is especially relevant in case that the door cannot be opened after a fire. The establishing of such an evacuation passage will be much more demanding if the door leaf contains stiffening elements.

1. A fire door leaf for industrial use related to openings in structures such as buildings, vessels and/or land and sea-based oil and gas installation, where the fire door leaf is constructed to function as an element in a certified barrier against the spread of fire, smoke and/or pressure, where the door leaf comprises two leaf elements constructed primarily of metal, where each leaf element comprises a main surface, and where the leaf elements assembled are suitable to form a volume between themselves, characterised by that
at least a main surface (2a, 3a) comprises a single-curved surface, and where the surfaces that the leaf elements (2, 3) form against the door leaf's (1) inner volume, forms continuous smooth surfaces without attached stiffening elements, where the fire door leaf (1) is constructed to expand mainly uniformly without twisting when heated.

2. The fire door leaf according to claim 1, where said volume without stiffening elements increases the insulating ability of the door leaf (1).

3. The fire door leaf according claim 1, where one of the curved surfaces is convex seen from the outside of the fire door leaf (1) towards said surface.

4. The fire door leaf according claim 1, where a second main surface in relation to the at least one other main surface, is mainly flat.

5. The fire door leaf according to claim 1, where a second main surface in relation to the at least one other main surface, comprises a single-curved surface that is convex seen from the outside of the fire door leaf (1) towards the last-mentioned surface.

6. The fire door leaf according to claim 1, where a second main surface in relation to the at least one other main surface, involves at least one single-curved surface that is concave seen from the outside of the fire door leaf (1) towards the last-mentioned surface.

7. The fire door leaf according claim 1, where the surfaces that the leaf elements (2, 3) form against the fire door leaf's (1) inner volume, primarily are monotonously curving so they form smooth surfaces that allow arrangement of continuous physical elements for example in the form of insulating material.

8. The fire door according to claim 7, where said inner volume mainly is filled with insulating material that can be in solid state or injected

9. The fire door leaf according claim 1, where two of the main surfaces (2a, 3a) are rectangular.

10. The fire door leaf according claim 1, further comprising devices (6) to provide visual inspection through the door leaf.

11. The fire door leaf according to claim 10, where said devices comprise window-like elements and where the door leaf (1) is constructed to allow that the window can essentially be installed anywhere on the main surfaces of the door leaf (1).

12. The fire door leaf according claim 1, where the door leaf (1) when subject to pressure against a main surface that includes a single-curved surface is arranged so that it transfers forces to a door frame (4) along said main surface, so that the seal against the door frame is enhanced.

13. The fire door leaf according claim 2, where one of the curved surfaces is convex seen from the outside of the fire door leaf (1) towards said surface.

14. The fire door leaf according claim 2, where a second main surface in relation to the at least one other main surface, is mainly flat.

15. The fire door leaf according claim 2, where a second main surface in relation to the at least one other main surface, comprises a single-curved surface that is convex seen from the outside of the fire door leaf (1) towards the last-mentioned surface.

16. The fire door leaf according claim 2, where a second main surface in relation to the at least one other main surface, involves at least one single-curved surface that is concave seen from the outside of the fire door leaf (1) towards the last-mentioned surface.

17. The fire door leaf according claim 3, where one of the curved surfaces is convex seen from the outside of the fire door leaf (1) towards said surface.

18. The fire door leaf according claim 3, where a second main surface in relation to the at least one other main surface, is mainly flat.

19. The fire door leaf according claim 3, where a second main surface in relation to the at least one other main surface, comprises a single-curved surface that is convex seen from the outside of the fire door leaf (1) towards the last-mentioned surface.

20. The fire door leaf according claim 2, where a second main surface in relation to the at least one other main surface, involves at least one single-curved surface that is concave seen from the outside of the fire door leaf (1) towards the last-mentioned surface.
